(19) United States
(12) Patent Application Publication
(10) Pub. No.: US 2024/0336131 A1
(43) Pub. Date: Oct. 10, 2024

(54) CLUTCH ASSEMBLY FOR A DIFFERENTIAL OF A MOTOR VEHICLE

(71) Applicant: ZF Friedrichshafen AG, Friedrichshafen (DE)

(72) Inventors: Kim FÜHRER, Lindau (DE); Matthias WINKEL, Weingarten (DE); Philipp EDER, Mauth (DE); Alois BÖCK, Hutthurm (DE); Benedikt MAIERHOFER, Vilshofen an der Donau (DE)

(73) Assignee: ZF Friedrichshafen AG, Friedrichshafen (DE)

(21) Appl. No.: 18/293,244

(22) PCT Filed: Aug. 17, 2022
(86) PCT No.: PCT/EP2022/072954

§ 371 Date: Jan. 29, 2024

(30) Foreign Application Priority Data
Aug. 18, 2021 (DE) 10 2021 209 026.5

(51) Int. Cl. B60K 17/02; B60K 23/04; F16H 48/08; F16H 48/40

(52) U.S. Cl. CPC B60K 17/02; B60K 23/04; F16H 48/08; F16H 48/40; B60Y 2400/40

(57) ABSTRACT

Coupling device (1) for a differential (2) of a motor vehicle, has a drive gear (3) and an inner differential carrier (4) which at least partially surrounds at least one bevel differential side gear (5) and at least one bevel differential pinion (6). An actuating device (7) is configured to move a coupling element (8), into a coupling state by the actuating device (7), particularly by means of an actuating element (9), to couple the inner differential carrier (4) with the drive gear (3) and move the coupling element (8) into a decoupling state by the actuating device (7) to decouple the inner differential carrier (4) from the drive gear (3).

### PRIORITY CLAIM

This is a U.S. national stage of application No. PCT/EP2022/072954, filed on Aug. 17, 2022. Priority is claimed on German Application No. 10 2021 209 026.5, filed Aug. 18, 2021; the content of which is incorporated herein by reference.

### BACKGROUND OF THE INVENTION

The invention is directed to a coupling device for a differential of a motor vehicle, which differential has a drive gear and an inner differential carrier which at least partially surrounds at least one bevel differential side gear and at least one bevel differential pinion. An actuating device is configured to move a coupling element, particularly a sliding sleeve, into a coupling state by means of the actuating device, particularly by means of an actuating element, in order to couple the inner differential carrier with the drive gear and to move the coupling element into a decoupling state by means of the actuating device in order to decouple the inner differential carrier from the drive gear.

Such coupling devices for differentials of motor vehicles are known in principle from the prior art. The coupling devices are usually utilized to decouple a portion of the differential and, therefore, a portion of the drivetrain of the motor vehicle, for example, in order to increase the efficiency of the motor vehicle in a decoupled state or decoupling state. To this end, for example, the drive gear of the differential can be decoupled from the inner differential carrier so that only the output-side components of the differential continue to be driven, or need be driven, via the wheels. In this way, the inertia of the drivetrain can be reduced and fuel consumption can accordingly be improved.

In order to bring the coupling element into the corresponding states for coupling or decoupling, an actuating device is required which is configured to produce the coupling state and decoupling state in a defined manner. In order to change between the coupling state and the decoupling state, i.e., to move out of the coupling state into the decoupling state or out of the decoupling state into the coupling state, it is necessary that the actuating device contact the coupling element in order to move the coupling element between the two states. Since the coupling element ultimately produces the coupling between the two parts of the differential which can be decoupled from one another, the coupling element—at least in the coupled state—carries out a rotational movement relative to static or fixed elements of the coupling device. Because of this rotational movement, contact of the coupling element throughout the operation of the coupling device leads to friction which, for one, reduces the efficiency of the coupling device or of the motor vehicle having the coupling device and causes wear between the contact surfaces.

### SUMMARY OF THE INVENTION

An object of the invention is to provide an improved coupling device for a differential of a motor vehicle.

This object is met by a coupling device for a differential of a motor vehicle as described below. The coupling device provides an actuating device which can move a coupling element between the coupling state and the decoupling state. To this end, the actuating device provides at least one actuating element by means of which the coupling element can be moved at least from the decoupling state into the coupling state or from the coupling state into the decoupling state. It is likewise possible that the actuating element is utilized to initiate or cause both changes of state. The coupling element can be actively adjusted by means of the actuating device into one of the two states and back, for example, in a spring-loaded manner.

The invention relies on the insight that the actuating device is configured to adjust the actuating element in the coupling state and the decoupling state at a distance from the coupling element or to arrange the actuating element and the coupling element on the input side. In other words, the coupling element is adjusted to the two states in a contactless manner so that there is no contact between the actuating element and the coupling element. In this way, in particular, no friction is allowed to occur between the coupling element and the actuating element in the coupling state or in the decoupling state because the coupling element and the actuating element are not in contact with one another. Accordingly, in the decoupling state in which the coupling element rotates together with the output of the differential and in which the input of the differential and the actuating element are stationary, there is nevertheless no friction between the coupling element and the actuating element because the coupling element and actuating element can be positioned at a distance from one another. Alternatively, it may also be provided that an actuating element is arranged on the output side so that the actuating element rotates together with the coupling element in the decoupling state, and the actuating element and coupling element rotate together with the drive gear in the coupling state.

Accordingly, the actuating element and the coupling element can be arranged on the input side. In this way, it continues to be ensured that there is no difference in speed between the coupling element and the actuating element, but rather the coupling element and the actuating element can both be supported on the input side, for example, at the outer differential carrier or at the drive gear. In the coupling state, the parts of the differential rotate at the same speed so that no difference in speed and, therefore, no friction occur in the coupling state.

It is advantageously brought about that the efficiency of the motor vehicle having the coupling device is further improved. In addition, wear between the contact surfaces of the actuating element and coupling element is significantly reduced. Consequently, wear or friction between the two elements can only occur during a changeover between the two states in which the speed parity between the input and the output is produced.

Therefore, with the coupling device, it is possible in principle to couple the inner differential carrier with the drive gear which is arranged in particular at an outer differential carrier. In so doing, the inner differential carrier surrounds the components which are usually received in the differential, for example, the two bevel differential side gears and the two bevel differential pinions. The coupling can be produced by means of the coupling element in any number of ways in principle. In particular, a fitting spline or driving spline can be provided which can be brought into engagement with one another by means of the coupling element. The coupling element itself may be constructed, for example, as a sliding sleeve or as a claw which can be actuated via a pressure disk. The pressure disk can be guided through bore holes into a part of the inner differential carrier, for example, via bolts. The drive gear described above can be connected to individual parts of the carrier by weld connections and can accordingly produce a fixedly connected unit with the outer differential carrier.

Accordingly, when the coupling device is brought into the coupling state, the coupling device is configured to couple the outer differential carrier, which is coupled to the drive gear in the coupling state, to the inner differential carrier. This inner differential carrier may also be referred to as bevel differential pinion carrier. Correspondingly, the coupling is disconnected in the decoupling state so that the uncoupled components need not be carried along, or a driving of only one driven axle can take place. For example, the decoupling state can be occupied in a sailing mode of the motor vehicle in order to reduce the rotating parts of the motor vehicle or drivetrain. A switchable all-wheel-drive operation may also be realized, for example.

The actuating device described above can have an actuator which is configured to move the coupling element into the decoupling state, particularly against a spring force transmitted to the coupling element by a spring element, or to move the coupling element into the coupling state and decoupling state. In principle, the actuator can be constructed in a comparatively simpler manner because the actuator need ultimately only move into two end positions. Correspondingly, one of the two end positions can be associated with the coupling state and the other end position can be associated with the decoupling state.

Accordingly, the actuator produces a movement by which the actuating element can be moved to bring the coupling element into the two states. The end positions of the actuator may be selected in such a way that the actuating element carries the coupling element along into the respective states, but there is no longer any contact between the actuating element and the coupling element in the end positions. For example, the movement produced by the actuator is selected in such a way that the actuating element moves the coupling element into its states but travels an additional distance which disconnects the actuating element from the coupling element again. Accordingly, in the coupling state and decoupling state, there is always a distance between the contact surfaces of the coupling element and actuating element so that the two parts which are rotatable relative to one another do not touch. Alternatively, as has been described, an embodiment in which the elements are arranged together on the input side can be used.

In principle, as described in the introduction, the actuator or actuating element of the actuating device can be provided for carrying out the change of state in only one direction, for example, from the decoupling state to the coupling state or from the coupling state to the decoupling state. It is also possible that the actuator and the actuating element are configured to carry out both changes of state. To this end, the actuating device can have a claw element which is coupled with the actuator and which provides a slot in which an engagement portion of the coupling element is received, and the actuator is configured to put the claw element in at least one end position in such a way that the engagement portion of the coupling element is at a distance from the walls of the slot.

In particular, the claw element can be provided by the actuating element or can be a component part of the actuating element or an actuating element constructed as a claw element can be used. The claw element is supported so as to be movable through the actuator and provides a slot in which the engagement portion of the coupling element can engage or can be received therein. The slot is dimensioned such that a distance is maintained from the engagement portion of the coupling element in both adjusting directions. Accordingly, the slot is U-shaped, for example, in order to receive the engagement portion of the coupling element. The slot has two opposite walls which can be brought into contact with the engagement portion for moving the coupling element in order to transmit an actuating force to the engagement portion and, accordingly, move the coupling element between the two states. In the individual states, the claw element can be adjusted such that the engagement portion of the coupling element is received in the slot but does not touch the walls of the slot and, rather, is at a distance from the latter in axial direction. This ensures that the actuating element and the coupling element are in the end positions at a distance from one another without contacting.

According to this configuration, the actuator can therefore produce a movement in coupling direction and a movement in decoupling direction in order to produce a movement of the coupling element in both directions by means of the actuating element which has the claw element, is formed as such a claw element or is coupled with a claw element. In other words, the coupling element can be moved into and out of, for example, pushed into and pulled out of, the decoupling state and the coupling state by means of the claw element. It can be provided to lock the coupling element in the individual states in a corresponding manner so that the individual states can be securely maintained until a displacement of the position of the coupling element is initiated through the actuating device. Further, means for position monitoring which are configured to detect a position of the actuating element and/or of the claw element and/or of the coupling element can be associated with the actuating element and/or the coupling element.

According to a further configuration of the coupling device, it can be provided that the actuating device has a spring element which is configured to transmit to the coupling element an engagement force, particularly against a disengagement movement generated by an actuator, or a disengagement force against an engagement movement generated by an actuator. The spring element described above can also be conceived as an actuating element within the meaning of the present invention because the spring element can be provided for moving the coupling element out of the decoupling state into the coupling state or out of the coupling state into the decoupling state.

The actuator generates the oppositely running movement so that a coupling element which is in the coupling state can be brought into the decoupling state by the actuator, and the spring element exerts a corresponding return force on the coupling element. Accordingly, in the absence of the actuation generated by the actuator, the spring force of the spring element moves the coupling element into the respective intended position. When the coupling element is in the decoupling state, it is also possible to use the actuator to bring the coupling element into the coupling state, and the spring element is arranged correspondingly in order to build up the spring force and, insofar as it is initiated by the actuating device, to return the coupling element to the decoupling state. In particular, any spring, for example, a helical spring or a spring assembly comprising a plurality of individual springs, can be used as spring element.

According to a further configuration of the coupling device, the actuating device can be configured to push or pull the spring element into the coupling state or decoupling state during a movement of the coupling element. As has been described, the coupling element is optionally couplable with the spring element so that the spring element can build up the spring force and transmit it to the coupling element, respectively. In principle, the spring element can be arranged at different sides of the coupling element or toward different sides of the coupling element. Accordingly, by means of the actuator, a pulling movement or a pushing movement is generated via the actuating element and the coupling element and correspondingly transmitted to the spring element via the actuating element and coupling element. Therefore, the direction in which the spring element is compressed in order to build up the spring force that can be used for a subsequent movement of the coupling element into the other respective state can be determined depending on the arrangement of the spring element.

As has been described, the actuating element and the coupling element can be arranged in any number of ways in principle. The coupling element and the actuating element and possibly the spring element are advantageously mounted at the drive gear or outer differential carrier. In particular, this allows the inner differential carrier to remain rotatable relative to the outer differential carrier and, therefore, also relative to the coupling element and the spring element and actuating element in the decoupling state.

In particular, another possible arrangement consists in that the actuating element and the coupling element are supported so as to be rotatable relative to one another, and the actuating device is formed in such a way that a rotational movement occurs between the coupling element and actuating element only in a closing movement. “Closing movement” within the framework of the present application means the changeover from the decoupling state to the coupling state. Accordingly, in the decoupling state, there is a rotational movement between the output-side and input-side portions of the differential. As has been described, the actuating element and the coupling element are adjusted into the decoupling state and coupling state in a contact-free manner.

Accordingly, during the closing movement, the coupling is produced so that the two parts of the differential are coupled together. Therefore, speed parity is produced during this closing movement. Accordingly, a difference in speed between the coupling element and actuating element can only occur during the closing movement because the actuating element contacts the coupling element for this purpose and the difference in speed between the coupling element and actuating element is reduced. Accordingly, in an advantageous manner, the friction occurs only during the changeover phase and there is no slippage between the coupling element and actuating element in the other operating states.

The coupling device can be further developed in such a way that the actuating device, particularly the coupling element and the spring element, are arranged at least partially inside of the drive gear. In particular, this means that the actuating device, particularly the coupling element and the spring element, are received in axial direction and/or in radial direction inside the contour of the drive gear. This makes possible a particularly compact construction, since the components of the actuating device do not extend beyond the original dimensions of the differential, and the installation space that was originally available is sufficient to receive the coupling device.

The invention is additionally directed to a differential which comprises a coupling device described above.

The invention is further directed to a transmission device. The transmission device comprises a step-down gear unit in addition to the differential. The step-down gear unit can be formed as a helical gear unit or as a planetary gearset. The step-down gear unit can preferably have one or two stages. Further, it can advantageously have one or two speeds.

The invention is additionally directed to an electric axle for a motor vehicle with an electric machine and a transmission device with a step-down gear unit and a differential. The electric axle is characterized in that the transmission device is formed as described above. The electric machine can be arranged coaxial to or axially parallel to the side shafts. It can be formed as an ASM or PSM or FSM.

The invention is further directed to a motor vehicle comprising a differential and/or an electric axle and/or a transmission device as described above.

### BRIEF DESCRIPTION OF THE DRAWINGS

The invention will be described in the following based on embodiment examples referring to the drawings. The drawings are schematic and show:

FIG. 1 a transmission device for a motor vehicle comprising a coupling device in a decoupling state according to a first embodiment example;

FIG. 2 the transmission device of FIG. 1 in a coupling state; and

FIG. 3 the transmission device of FIG. 1 according to a second embodiment example.

### DETAILED DESCRIPTION OF THE PRESENTLY PREFERRED EMBODIMENTS

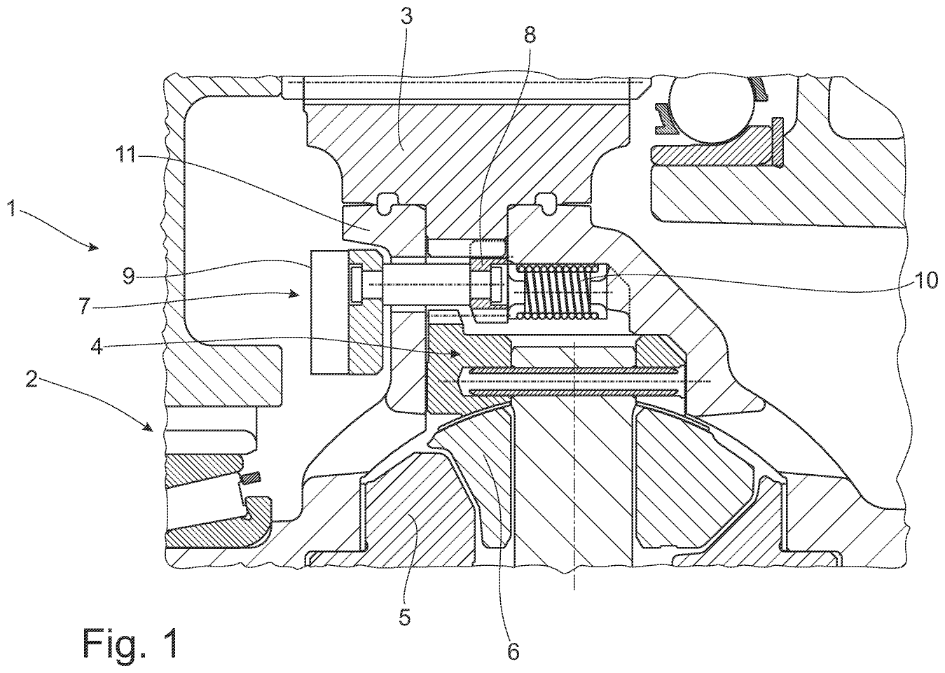

FIG. 1 shows a section of a transmission device with a coupling device 1 for a differential 2 of a motor vehicle, not shown in greater detail, which differential 2 has a drive gear 3 and an inner differential carrier 4 which at least partially surrounds two bevel differential side gears 5 and two bevel differential pinions 6. An actuating device 7 is configured to move a coupling element 8, particularly a sliding sleeve, by means of the actuating device 7, particularly by means of an actuating element 9, into a coupling state in order to couple the inner differential carrier 4 with the drive gear 3 and to move the coupling element 8 by means of the actuating device 7 into a decoupling state in order to decouple the inner differential carrier 4 from the drive gear 3.

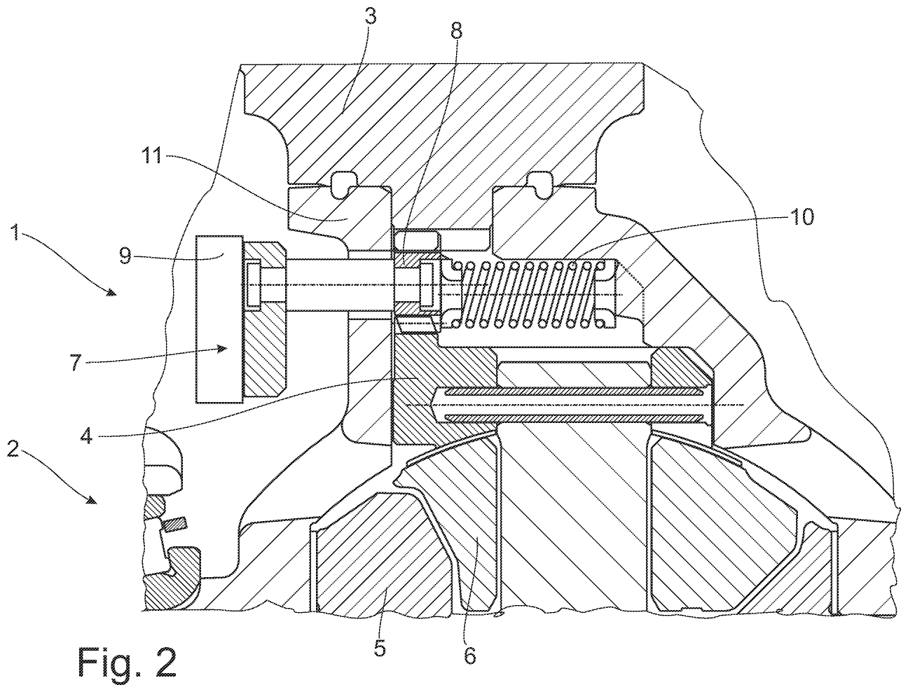

In the first embodiment example according to FIGS. 1, 2, an actuator, not shown in more detail, is provided which is configured to move the actuating element 9 between the decoupling state shown in FIG. 1 and the coupling state shown in FIG. 2. The actuating device 7 additionally has a spring element 10 which is configured to transmit a spring force to the coupling element 8. Accordingly, in the situation shown in FIG. 1, the spring element 10 exerts a spring force on the coupling element 8 which causes a movement of the coupling element 8 into the coupling state shown in FIG. 2, i.e., on the left-hand side of the drawing.

The coupling element 8 can have corresponding detents which hold the coupling element 8 in the individual states. It may also be provided that the actuator holds the actuating element 9 in the decoupling state against the spring force of the spring element 10. Since the actuating element 9, the coupling element 8 and the spring element 10 are arranged on the input side, particularly at an outer differential carrier 11, there is no relative movement carried out between the actuating element 9, the coupling element 8 or the spring element 10.

In order to change from the decoupling state shown in FIG. 1 into the coupling state, the coupling element 8 which can be constructed, for example, as a sliding sleeve, is moved in order to produce the connection between the outer differential carrier 11 and the inner differential carrier 4. For this purpose, the coupling element 8 has an outer toothing and an inner toothing so that the inner toothing of the drive gear 3 can be coupled with the outer toothing of the differential carrier 4. Further, the drive gear 3 is welded to the outer differential carrier 11 so that the drive gear 3 and the outer differential carrier 11 form an inseparable unit.

FIG. 2 shows the coupling state in which the coupling element 8 engages in the toothing at the inner differential carrier 4 and accordingly produces the coupling between the drive gear 3 and the inner differential carrier 4. To change from the decoupling state to the coupling state, the spring element 10 can expand and accordingly displace the coupling element 8 and, along with the coupling element 8, the actuating element 9. In other words, the spring force is at least partially reduced in order to displace the coupling element 8 and, therefore, to produce the coupling between the drive gear 3 and the inner differential carrier 4. If the inner differential carrier 4 is to be decoupled again, the actuator can move the actuating element 9 and, accordingly, the coupling element 8 in the decoupling direction, and the spring element 10 is compressed and a corresponding return force is built up. Accordingly, the situation depicted in FIG. 2 can be changed to the situation depicted in FIG. 1.

Therefore, a relative movement between the coupling element 8, the actuating element 9 and the spring element 10 occurs at most during a changeover from the decoupling state into the coupling state, since the inner differential carrier 4 is rotatable relative to the drive gear 3 in the decoupling state. The difference in speed is reduced during the changeover to the coupling state because the drive gear 3 and the inner differential carrier 4 are subsequently coupled together via the coupling element 8. In this changeover, the difference in speed can be reduced by means of a rotatable support between the spring element 10 and the coupling element 8 until the teeth engage with one another.

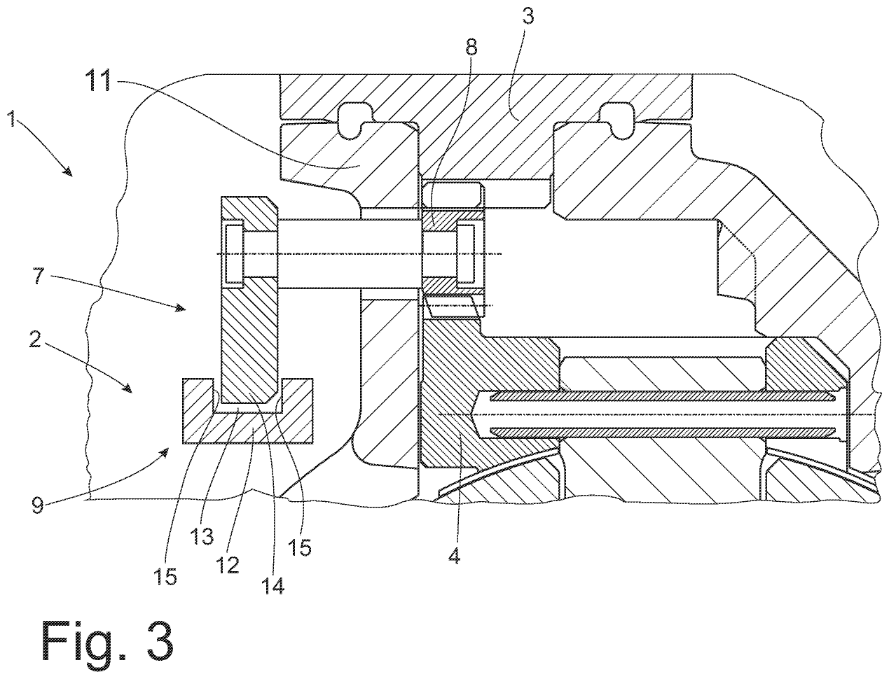

FIG. 3 shows a further configuration in which the spring element 10 can be dispensed with. Analogous to FIG. 2, FIG. 3 shows the coupling state in which the coupling element 8 produces the connection between the drive gear 3 and the inner differential carrier 4. The actuating element 9 additionally has a claw element 12 which provides a slot 13 in which an engagement portion 14 of the coupling element 8 engages. Accordingly, it is possible that the actuator, not shown in more detail, moves the actuating element 9 which is formed as a claw element 12 or has the claw element 12 or is coupled with a claw element 12. The slot 13 has walls 15 which can contact the coupling element 8 at the engagement portion 14 in order to displace the coupling element 8.

Further, the actuating device 7 is configured to adjust the actuating element 9 in such a way that there is a distance between the walls 15 and the engagement portion 14 both in the coupling state and in the decoupling state. This means that in the coupling state as well as in the decoupling state the coupling element 8 is at a distance from the actuating element 9 and, therefore, the coupling element 8 and actuating element 9 do not make contact.

Accordingly, in an advantageous achievement, no friction occurs between the actuating device 7 and the coupling element 8 either in the coupling state or in the decoupling state. In both states, the actuating element 9, coupling element 8, spring element 10 can be stationary or can be at the same speed or, in case of a difference in speed between the individual components, the actuating element 9 or claw element 12 can be spaced apart in a corresponding manner so that no friction occurs.

The advantages, details and features shown in the individual embodiment examples are combinable, exchangeable and transferable with one another.

1. A coupling device for a differential of a motor vehicle, which differential has a drive gear and an inner differential carrier which at least partially surrounds at least one bevel differential side gear and at least one bevel differential pinion, wherein an actuating device is configured to move a coupling element into a coupling state by means of the actuating device, to couple the inner differential carrier with the drive gear and move the coupling element into a decoupling state by the actuating device to decouple the inner differential carrier from the drive gear, wherein either the actuating device is configured to adjust the actuating element in the coupling state and the decoupling state at a distance from the coupling element, or the actuating element and the coupling element are arranged on the input side.

2. The coupling device according to claim 1, wherein the coupling device is configured to couple an outer differential carrier, which is coupled to the drive gear in the coupling state, to the inner differential carrier.

3. The coupling device according to claim 1, wherein the actuating device has an actuator which is configured to move the coupling element into the decoupling state, or to move the coupling element into the coupling state and decoupling state.

4. The coupling device according to claim 1, wherein the actuating device has a claw element which is coupled with the actuator and which provides a slot in which an engagement portion of the coupling element is received, wherein the actuator is configured to put the claw element in at least one end position in such a way that the engagement portion of the coupling element is at a distance from the walls of the slot.

5. The coupling device according to claim 1, wherein the actuating device has a spring element configured to transmit to the coupling element an engagement force against a disengagement movement generated by an actuator.

6. The coupling device according to claim 5, wherein the actuating device is configured to push or pull the spring element into the coupling state or decoupling state during a movement of the coupling element.

7. The coupling device according to claim 1, wherein the actuating element and the coupling element are supported so as to be rotatable relative to one another, wherein the actuating device is formed in such a way that a rotational movement occurs between the coupling element and actuating element only in a closing movement.

8. The coupling device according to claim 5, wherein the actuating device and the spring element, are arranged at least partially inside of the drive gear.

9. A differential for a motor vehicle, comprising a coupling device according to claim 1.

10. A transmission device having a step-down gear unit and a differential, wherein the differential is configured according to claim 1.

11. An electric axle for a motor vehicle with an electric machine and a transmission device with a step-down gear unit and a differential, wherein the transmission device is formed according to claim 10.

12. A motor vehicle comprising an electric axle according to claim 11.

13. A motor vehicle comprising a transmission device according to claim 10.

14. A motor vehicle comprising a differential according to claim 9.

15. The coupling device of claim 1, wherein the inner differential carrier comprises a bevel differential pinion carrier.
